(19) United States
(12) Patent Application Publication
(10) Pub. No.: US 2002/0090037 A1
(43) Pub. Date: Jul. 11, 2002

(54) System and method for variable bandwidth transmission

(76) Inventors: Xiaoyun Hu, Ottawa (CA); Steve A. Beaudin, Ottawa (CA); John J. Nisbet, Nepean (CA); Conrad F. Gratton, Casselman (CA)

Correspondence Address: SMART & BIGGAR, Suite 3400, 1000 de la Gauchetiere Street West, Montreal, QC, H3B 4W5, CA

(21) Appl. No.: 10/022,430

(22) Filed: Dec. 20, 2001

Related U.S. Application Data
(63) Continuation-in-part of application No. 09/220,076, filed on Dec. 23, 1998.

(51) Int. Cl. H04K 1/02

(52) U.S. Cl. 375/296

(57) ABSTRACT

A device and method used to transmit/receive an input message bearing signal at variable bandwidths using a variable frequency bandwidth control signal as an input for changing the bandwidth of the output signal.

### CROSS REFERENCE TO RELATED APPLICATION

This application is a continuation in part of U.S. patent application Ser. No. 09/220,076 filed on Dec. 23, 1998 by Steve A. Beaudin et al.

### FIELD OF THE INVENTION

The present invention relates to systems and methods used to transmit data at variable rates. The systems and methods use a variable frequency bandwidth control signal as an input for changing the bandwidth of the output signal.

### BACKGROUND OF THE INVENTION

In the context of wideband wireless radio transceivers, there is a requirement to perform filtering in order to meet the U.S. Federal Communication Commission (FCC) mask requirements in America and other regulatory bodies elsewhere. That is, a radio transceiver is allocated a certain frequency range and the gain of all side lobes outside this range must be below a specified level (e.g., 13 dB reduction). In order to meet the FCC mask, radio transceivers must therefore include filters that fulfil this task.

Furthermore, in view of the convergence of voice, video and data networks, clients are requesting bandwidth on demand. That is, depending on the type of information that needs to be sent on the network, clients are ready to pay for different bandwidths required for each type of information.

Various types of devices comprising filter arrangements exist to provide at least some of the requirements listed above. But most have significant drawbacks. Thus there exists a need in the industry to provide a simple, low cost and efficient variable bandwidth transmission device.

### SUMMARY OF THE INVENTION

The invention provides a novel variable bandwidth transmission device that links the bandwidth control (of the output signal) to a variable frequency bandwidth control signal. In a non-limiting example of implementation of the invention, the frequency of the bandwidth control signal is a function of the bandwidth of the input signal (message bearing signal).

In a specific, non-limiting example, the variable bandwidth transmission device has a filtering stage using two band pass filters. Alternatively, the filtering stage is a spectral shaping filtering stage.

This inventive principle can also be applied to a receiver. In such a case, the direction of data flow is changed; otherwise the structure and operation remain the same.

Under another broad aspect, the invention provides a novel local oscillator manager for use in the transmitter or the receiver, as described above. The local oscillator manager has one or more single side band up converters to generate signals at determined frequencies for use by the filtering stage of the transmitter or receiver.

In yet another broad aspect, the invention provides a communication system based on the transmitter and the receiver described above that, where the transmitter sends RF signals to the receiver.

### BRIEF DESCRIPTION OF THE DRAWINGS

FIG. 1 is a block diagram of a variable bandwidth transmission device in accordance with a first embodiment of the invention;

FIG. 2 is a block diagram of a variable bandwidth reception device in accordance with an embodiment of the invention;

FIG. 3 is a block diagram of a single side band up converter; and

FIG. 4 is a block diagram of a variable bandwidth reception device in accordance with a second embodiment of the invention using the single side band up converter shown in FIG. 3.

In the drawings, embodiments of the invention are illustrated by way of example. Whenever possible, the same reference numerals are used to designate similar or identical elements. It is to be expressly understood that the description and drawings are . only for purposes of illustration and as an aid to understanding, and are not intended to be a definition of the limits of the invention.

### DETAILED DESCRIPTION OF A PREFERRED EMBODIMENT

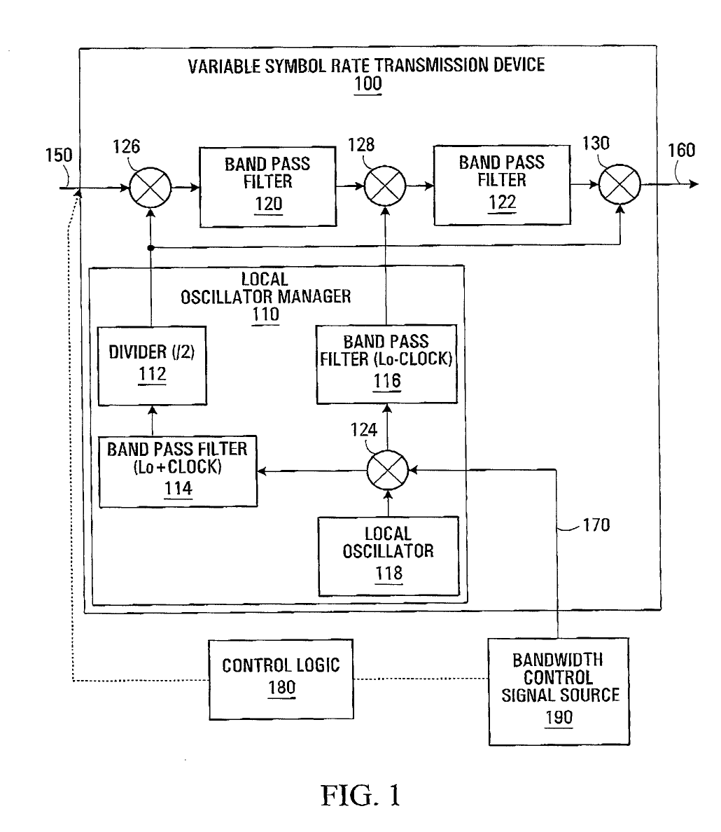

FIG. 1 is a block diagram of a variable bandwidth transmission device 100 in accordance with the invention. The variable bandwidth transmission device 100 includes a filtering stage having two band pass filters (120 and 122), and three mixers (126, 128, and 130). The variable bandwidth transmission device 100 further includes a local oscillator manager 110. The local oscillator manager 110 comprises divider 112, two bandpass filters (114 and 116), a mixer 124 and a local oscillator 118. The variable bandwidth transmission device 100 receives, as input 170, a bandwidth control signal and, as input 150, the baseband signal, which carries the message and can also be referred to as the information-bearing signal. The output 160 of the variable bandwidth transmission device 100 is an Intermediate Frequency (IF) signal that can be further processed to obtain the appropriate Radio Frequency (RF) level and transmitted over the air medium. The structure performing the processing to obtain the RF level is not shown in the drawings.

The variable bandwidth transmission device 100 produces an output signal 160 at an intermediate frequency having a bandwidth, which varies depending on the chosen frequency of the. bandwidth control signal at input 170. For optimal bandwidth usage, the bandwidth should be equal to the Nyquist frequency. This however is not an absolute requirement and the inventive principle is not limited to this feature. Effectively, the bandwidth control signal at input 170 determines the bandwidth of the IF output signal 160. A user may therefore choose the bandwidth control signal (input 170) depending upon the type of data to be transmitted, in other words the bandwidth of the input signal or message-bearing signal. For example, a bandwidth control signal at a higher rate which translates into a higher bandwidth will be selected for video applications and a bandwidth control signal at a lower rate which translates into a lower bandwidth will be chosen for voice applications. This can be described as bandwidth on demand.

In an exemplary embodiment, input 150 is a stream of rectangular non-return to zero (NRZ) bits in the time-domain. The frequency spectrum of these rectangular bits is a very wide sinc function. In order to obtain a variable bandwidth transmission over wireless airwaves, it is advantageous to alter the frequency response to avoid introducing an excess amount of inter symbol interference (ISI). In other words filtering is performed such as to maintain in the output signal the intersymbol interference below a certain level. That level corresponds to a degree of intersymbol interference where decoding of the information can still be effected. When the symbols in the output signal do not significantly interfere with one another, the signal is characterized as being at or below the Nyquist frequency.

The filtering is accomplished by the combination of the two band pass filters 120 and 122. The band pass filter 120 will truncate the lower frequency components of a signal centered on a first intermediate frequency. The band pass filter 122 will truncate the higher frequency components of a signal centered on a second intermediate frequency. The time domain response of the bits will therefore change from short rectangular pulses to long sinc functions. The filter function performed by filters 120 and 122 will truncate the frequency domain of the bits (the long sinc function) and will result in an elongation of the pulse in the time domain. If the truncation is effected at the Nyquist frequency, each pulse (bit) in the time domain will cross zero (in amplitude) at the sampling instant (of the next bit).

Stated otherwise, the band pass filters 120, 122, adjust the sinc function of each bit in dependence of the bandwidth control signal frequency. That is, when the bandwidth control signal frequency increases, the band pass filters concurrently adjust the sinc functions of the symbols in the signal such that they do not interfere extensively in a manner that would prevent proper decoding at the receiver. Most preferably, the band pass filters are selected to maintain the sinc functions at the Nyquist frequency rate at all the possible bandwidth control signal frequencies.

In a specific example of implementation of the invention, the bandwidth control signal (input 170) may take on three values. For example, 5 MHz may be used for voice applications (A), 10 MHz may be used for data applications (B), and 20 MHz may be used for video applications (C). Input 170 is mixed with the local oscillator input 118 at mixer 124. In an embodiment of the invention, the local oscillator is set at 100 MHz.

The mixer 124 result will be sent to a first band pass filter 114 and a second band pass filter 116. The band pass of filter 114 would span from 105 MHz to 120 MHz in order to select the sum of the local oscillator frequency and chosen clock frequency (A=5 MHz; B=10 MHz; C=20 MHz). For this exemplary embodiment, the frequency of the output to band pass filter 114 is A=105 MHz; B=110 MHz; and C=120 MHz. This last output will then be divided by two in divider 112 thereby re-centering the frequency at A=52.5 MHz; B=55 MHz; and C=60 MHz The band pass of filter 116 would span from 80 to 95 MHz in order to select the difference of the local oscillator frequency and the chosen bandwidth control signal frequency. For the example embodiment, the frequency of the output to band pass filter 116 is A=95 MHz; B=90 MHz; and C=80 MHz.

The baseband message-bearing signal at input 150 (stream of rectangular NRZ bits) will be mixed with the output to divider 112 in mixer 126. The output of the mixer 126 is a signal where the spectrum of the baseband signal input 150 is centered at the frequency of the output to divider 112 (A=52.5 MHz; B=55 MHz; and C=60 MHz). The output to mixer 126 is a signal at the first intermediate frequency and is fed to the band pass filter 120.

In a specific example, the band pass filter 120 center frequency is set at 60 MHz with a pass band of 20 MHz (i.e., 60 MHz ±10 MHz). For all three examples, first intermediate frequencies and bandwidth control signal frequencies (A=52.5 MHz, 5 MHz; B=55 MHz, 10 MHz; and C=60 MHz, 20 MHz), the band pass filter would reject or at least strongly attenuate all the frequency components below the lower cut-off limit of 50 MHz.

The output of band pass filter 120 is fed to mixer 128 along with the output to band pass filter 116 (A=95 MHz; B=90 MHz; and C=80 MHz). The output of the mixer 128 is a signal where the spectrum of the output signal from the band pass filter 120 is found at the sum of the first intermediate frequencies and the frequency of the output of band pass filter 116 (A=147.5 MHz; 145 MHz; and 140 MHz). The output of mixer 128 is at the second intermediate frequency and is fed to the band pass filter 122.

In an embodiment of the invention, the band pass filter 122 center frequency is set at 140 MHz and has a pass band of 20 MHz (i.e., 140 MHz ±10 MHz). For all three examples, second intermediate frequencies and bandwidth control signal frequencies (A=147.5 MHz, 5 MHz; B=145 MHz, 10 MHz; and C=140 MHz, 20 MHz), the upper cut-off point, is at 150 MHz. The filter 122 would reject or at least strongly attenuate all frequency components above the upper cut-off point.

Also, the filters 120 and 122 are set to reduce frequency component in all side lobes by a sufficient amount as to meet the frequency mask requirement for a transmitter and to provide sufficient channel selection as a receiver.

The output band pass filter 122 is fed to mixer 130 for mixing with the output of divider 112. The resulting output 160 will be a signal at a third intermediate frequency (e.g., 200 MHz for A, B and C) containing the message information, but having a variable bandwidth (i.e., A=200 MHz ±5 MHz; B=200 MHz ±10 MHz; and C=200 MHz ±20 MHz). It will be appreciated that the transmitter 100 basically tracks the bandwidth of the message-bearing signal at input 150 and adjusts the bandwidth of the output signal (signal released at 160) accordingly. The higher the bandwidth of the message bearing signal, the higher the bandwidth of the output signal will be.

In a possible variant, the mixer 130 can be replaced by a Digital to Analog (DA) converter whose sampling rate is set by the divider 112, in other words, (A=52.5 MHz; B=55 MHz; and C=60 MHz).

In another possible variant, the band pass filters 120 and 122 can be replaced by spectral shaping filters, having upper and lower transition bands selected to truncate the undesirable frequencies.

FIG. 1 shows a control logic bloc 180 connected with dotted lines to the input 150 and to a bandwidth control signal source 190 that generates the bandwidth control signal applied at input 170. The control logic shows the relationship that may exist between the two signals applied at the inputs 150 and 170. In the case of bandwidth on demand applications, if the bandwidth of the signal at the input 150 changes, the frequency of the bandwidth control signal at input 170 should also be adjusted, as previously mentioned. This function is performed by the control logic 180. For instance, upon detection of a change, either actual or desired in the bandwidth of the signal at input 150, the control logic 180 notifies the source 190 of the bandwidth control signal to change its frequency accordingly. The control logic 180 can be implemented in many different ways without departing from the invention. In a possible example, the control logic is implemented in software. It should be expressly noted that the control logic 180 is an optional component. In other words, applications exist where the frequency of the bandwidth control signal can be varied while the bandwidth of the signal at the input 150 remains the same, such as when one desires to modulate the signal at input 150 with different carriers. Changing the carrier is achieved by changing the frequency of the bandwidth control signal at input 170 without changing the bandwidth at input 150. In another possibility, the frequency of the bandwidth control signal at input 170 can be varied based on knowledge about the bandwidth of the signal at input 150, without actually having to process the signal at input 150 in any way. The reader will appreciate that a variety of strategies can be used to adjust the frequency of the bandwidth control signal at input 170 in accordance with the bandwidth of the signal at input 150, without departing from the present inventive concept.

Naturally, a very similar structure to the one described above could be used for a receiver by simply changing the direction of the data so that it flows from the third intermediate frequency towards baseband rather than from baseband to the third intermediate frequency.

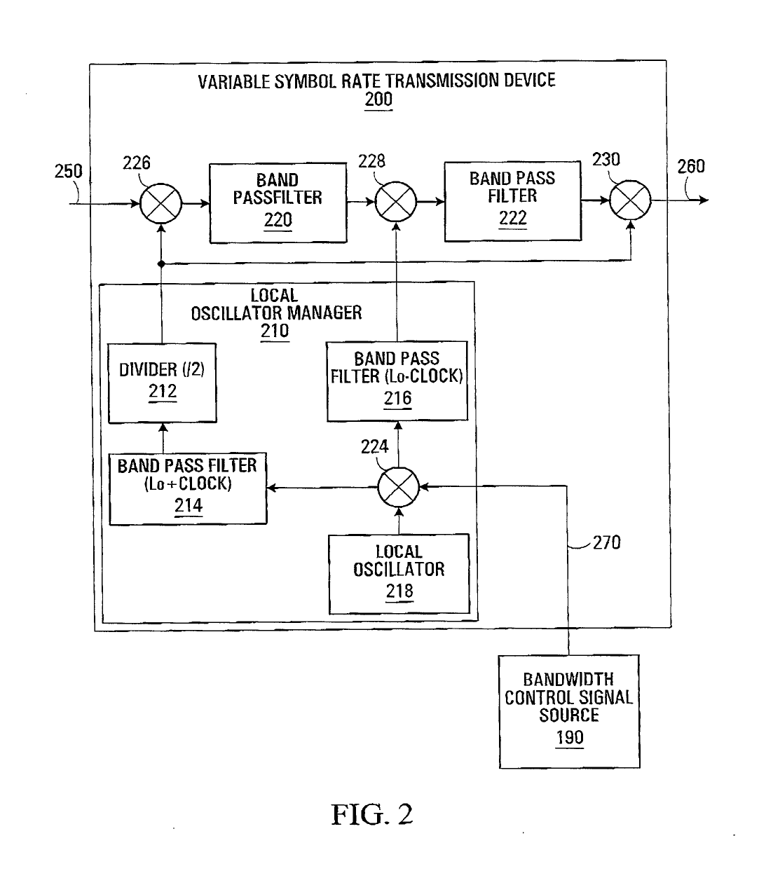

An embodiment of a reception device is depicted in FIG. 2. The variable bandwidth reception device 200 includes two band pass filters (220 and 222), three mixers (226, 228, and 230), and a local oscillator manager 210. The local oscillator manager 210 further comprises divider 212, two band pass filters (214 and 216), a mixer 224 and a local oscillator 218 The variable bandwidth transmission device 200 receives, as input 270, a bandwidth control signal and, as input 250, an Intermediate Frequency (IF) signal that was previously processed from an appropriate Radio Frequency (RF) level and received from the air medium. The output 260 to the variable bandwidth transmission device 200 is the baseband signal, which carries the message and can also be referred to as the information-bearing signal.

It should be noted that the bandwidth control signal at input 270, generated from the bandwidth control signal source 190 could be obtained from or controlled by a carrier recovery module at the RF stage of the receiver (the RF stage and the carrier recovery module are not shown). These components do not need to be described because they are known to those skilled in the art.

In a specific embodiment of the invention, the bandwidth control signal (input 270) may take on three values. For example, 5 MHz may be used for voice applications (A), 10 MHz may be used for data applications (B), and 20 MHz may be used for video applications (C) Input 270 is mixed with the local oscillator input 218 at mixer 224. In an embodiment of the invention, the local oscillator is set at 100 MHz.

The mixer 224 result will be sent to a first band pass filter 214 and a second band pass filter 216 The band pass of filter 214 would span from 105 MHz to 120 MHz in order to select the sum of the local oscillator frequency and chosen clock frequency (A=5 MHz; B=10 MHz; C=20 MHz). For this exemplary embodiment, the frequency of the output to band pass filter 214 is A=105 MHz; B=110 MHz; and C=120 MHz. This last output will then be divided by two in divider 212 thereby re-centering the frequency at A=52.5 MHz; B=55 MHz; and C=60 MHz. The band pass of filter 216 would span from 80 to 95 MHz in order to select the difference of the local oscillator frequency and the chosen clock frequency. For the example embodiment, the frequency of the output to band pass filter 216 is A=95 MHz; B=90 MHz; and C=80 MHz.

A signal at an intermediate frequency (e.g., 200 MHz for A, B and C) containing the message information, but having a variable bandwidth (i.e., A=200 MHz ±5 MHz; B=200 MHz ±10 MHz; and C=200 MHz ±20 MHz) is provided at input 250 and will be mixed with the output to divider 212 in mixer 226. The output of the mixer 226 is a signal with its spectrum centered at the frequency equal to the difference between the input 250 signal center frequency and divider 212 frequency (A=147.5 MHz; B=145 MHz; and C=140 MHz). The output to mixer 226 is fed to the band pass filter 220.

In a specific example, the band pass filter 220 center frequency is set at 140 MHz with a pass band of 20 MHz (i.e., 140 MHz ±10 MHz),

The output of band pass filter 220 is fed to mixer 228 along with the output to band pass filter 216 (A=95 MHz; B=90 MHz; and C=80 MHz). The output of the mixer 228 is a signal where the spectrum of the output signal from the band pass filter 220 is found at the difference of the frequency output by filter 220 and the frequency of the output to band pass filter 216 (A=52.5 MHz; 55 MHz; arid 60 MHz) The output to mixer 228 is fed to the band pass filter 222,

In an embodiment of the invention, the band pass filter 222 center frequency is set at 60 MHz and has a 3 dB bandwidth of 20 MHz (i.e., 60 MHz ±10 MHz).

The output band pass filter 222 is fed to mixer 230 for mixing with the output of divider 212. The resulting output 260 will be a baseband signal containing the message to be sampled and further converted to a digital signal. As was the case of the transmitter 100, the receiver 200 adjusts the bandwidth of the output signal (signal at output 260) depending on the bandwidth of the signal at input 250. It should be noted that the signal released from output 260 does not have to be at the baseband and can be at a different frequency that requires further processing to produce a baseband signal.

In a possible variant, the mixer 230 can be replaced by an Analog to Digital (DA) converter whose sampling rate is set by the divider 112, in other words, (A=52.5 MHz; B=55 MHz; and C=60 MHz).

In yet another possible variant, the band pass filters 220 and 222 can be replaced by spectral shaping filters, having upper and lower transition bands selected to truncate the undesirable frequencies.

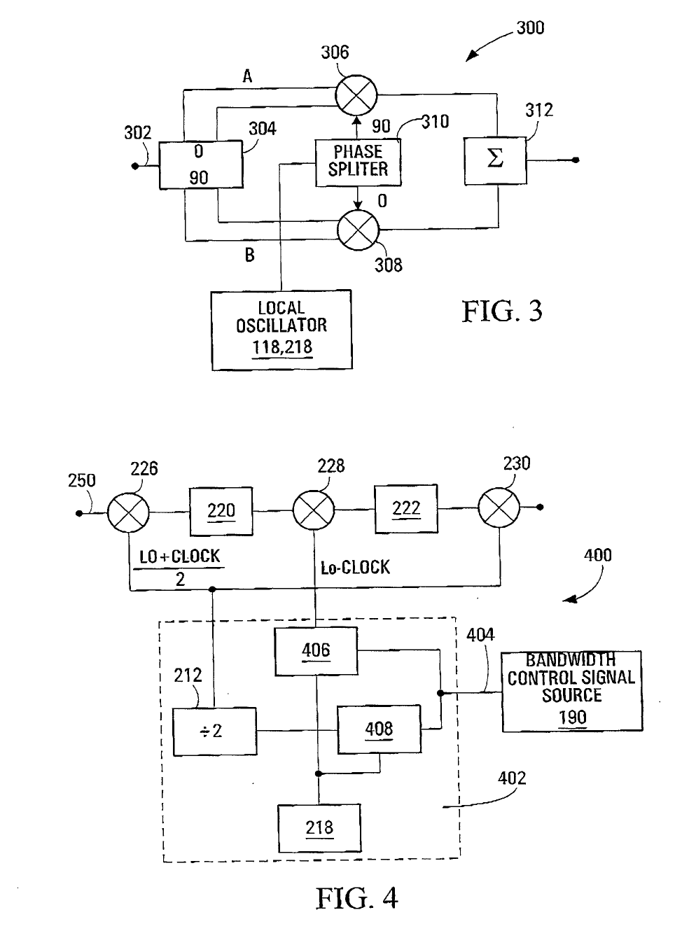

In yet another possible variant, a pair of single side band up converters can be used to replace the combination of mixer 224, and band pass filters 214 and 216. A single side band up converter 300 is shown at FIG. 3 Generally, the structure and operation of a single side band up converter is known in the art and as such a detailed description is not necessary here. Suffice it to say that the single side band up converter 300 has an input 302 at which is applied the bandwidth control signal. The input 302 is the input of a quad splitter 304 that generates two pairs of differential signals A and B, out of phase by 90 degrees. Each pair of signals is applied to a respective mixer 306, 308. Each mixer also receives the output of a phase splitter 310. The phase splitter has as input the local oscillator 118 signal (Lo). The outputs of the phase splitter 310 release the signal Lo out of phase by 90 degrees. The output of the mixers 306 and 308 is supplied to an adder 312. The output of the single side band up converter 300 can be either Lo+Clock or Lo-Clock. The selection. between the sideband that is being output can be made by changing the polarity of the differential signals A and B by 180 degrees or changing the polarity of the quad splitter 304.

FIG. 4 is a block diagram of a reception device 400 that uses two single side bands up converters. To avoid an unnecessary repetition, the reception device 400 is identical to the reception device 200 shown at FIG. 2 with the exception of the configuration of the local oscillator manager. The local manager 402 includes an input 404 receiving the bandwidth control signal and two single side band up converters 406, 408 receiving both the bandwidth control signal at input 404. Each single side band up converters 406, 408 also receives the output of the local oscillator (Lo) 218. The single side band up converter 406 is configured, as described earlier to output signal Lo-Clock while the single side band up converter 408 outputs Lo+Clock that is divided by two by divider 212 to generate the signal (Lo+Clock)/2. The local oscillator manager 402 presents some advantages over the local oscillator manager 210 in that it obviates the need for band pass filters.

It will be apparent to the reader that local oscillator manager 402 can be substituted to the local oscillator manager 110 in the transmitter 100.

In any one of the above-described embodiments, the bandwidth control signal input to the local oscillator manager 110, 210, 402 is equal to the symbol rate of the signals input at 150, 250. This however is not an essential requirement of the invention. It will become apparent to the reader that there are many practical applications where it will be advantageous to use a bandwidth control signal at a frequency other than the symbol rate of the signals input at 150, 250. Broadly stated, the bandwidth control signal is merely be related to the bandwidth of the signals input at 150, 250. Thus, the bandwidth control signal frequency can be expressed as f(X) where “X” is the bandwidth of the signal input at 150, 250. The function f is any arbitrary function of the bandwidth of the signals input at 150, 250. Examples include:

1. f(X)=A+X, where A is a constant and X is the bandwidth. An advantage of this embodiment is that the local oscillator manager outputs signals Lo−(A+X) and (Lo+A+X)/2, where the side bands are moved further apart which minimizes subsequent filtering requirements;

2. f(X)=B*X, where B is a constant and X is the bandwidth. If one desires to input in the oscillator manager f(X)=B*X and output from the oscillator manager Lo−Clock and Lo+Clock, the local oscillator manager should be modified such as to add a divider by B at the output of the band pass filter 116, 216 or at the output of the single side band up converter 406 such as to negate the effect of the multiplier B. Similarly, the dividers 112, 212 should be modified to divide by B*2. The advantage of this embodiment is to move the sidebands apart to facilitate signal processing at the level of the local oscillator manager;

3. f(X)=C*(D+X), where C and D are constants and X is the bandwidth.

It will be appreciated that many other possibilities of f(X) can be envisaged without departing from the spirit of the invention.

The above description of a preferred embodiment of the present invention should not be read in a limitative manner as refinements and variations are possible without departing from the spirit of the invention. The scope of the invention is defined in the appended claims and their equivalents.

We claim:

1. A variable bandwidth transmission device comprising:
a) a first input for receiving a message bearing signal;
b) a second input for receiving a bandwidth control signal characterized by a frequency, the frequency being selectively variable;
c) a filtering stage for processing the message bearing signal and the bandwidth control signal to generate an output signal characterized by a bandwidth, said filtering stage being responsive to a change of frequency of the bandwidth control signal to alter the bandwidth of the output signal.

2. A variable bandwidth transmission device as defined in claim 1, comprising:
a) a bandwidth control signal source connected to said second input for supplying the bandwidth control signal;
b) the message bearing signal characterized by a bandwidth;
c) a control logic coupled to said bandwidth control signal source for causing said bandwidth control signal source to change the frequency of the bandwidth control signal on the basis of a change of the bandwidth of the message bearing signal.

3. A variable bandwidth transmission device as defined in claim 1, wherein said filtering stage is a spectral shaping characterized by a Nyquist bandwidth, said spectral shaping filtering stage being responsive to a change of frequency of the bandwidth control signal to alter the Nyquist bandwidth of said spectral shaping filtering stage.

4. A variable bandwidth transmission device as defined in claim 3, wherein said spectral shaping filtering stage includes a first spectral shaping filter and a second spectral shaping filter.

5. A variable bandwidth transmission device as defined in claim 1, wherein said filtering stage includes band pass filters.

6. A variable bandwidth transmission device as defined in claim 5, wherein said filtering stage includes a first mixer having two inputs and an output, the output of said first mixer being coupled to an input of a first band pass filter, one input of said first mixer being coupled to said first input for receiving the message bearing signal, the other input of said first mixer receiving a signal at a first frequency.

7. A variable bandwidth transmission device as defined in claim 6, wherein said filtering stage includes a second mixer having two inputs and an output, one input of said second mixer being coupled to an output of said first band pass filter, one input of said second mixer receiving a signal at a second frequency, the output of said second mixer being coupled to an input of a second band pass filter.

8. A variable bandwidth transmission device as defined in claim 7, wherein said filtering stage includes a third mixer having two inputs and an output, one input of said third mixer being coupled to an output of said second band pass filter, one input of said mixer receiving the signal at the first frequency, the output of said second mixer generating the output signal characterized by a bandwidth.

9. A variable bandwidth transmission device as defined in claim 7, wherein said filtering stage includes a DA converter including a first input for receiving the output of said second band pass, a second input for receiving the signal at the first frequency and an output for releasing the output signal characterized by a bandwidth, the output signal characterized by a bandwidth being an analog signal.

10. A variable bandwidth transmission device as defined in claim 9, wherein said DA converter is characterized by a sampling frequency, the first frequency defining the sampling frequency of said DA converter.

11. A variable bandwidth transmission device as defined in claim 7, including a local oscillator manager including a local oscillator generating a local oscillator signal, said local oscillator manager being operative to generate from the local oscillator signal and from the bandwidth control signal the signal at the first frequency and the signal at the second frequency.

12. A variable bandwidth transmission device as defined in claim 11, wherein said local oscillator manager includes a mixer having two inputs for receiving the bandwidth control signal and the local oscillator signal, respectively and two outputs, coupled respectively to a first band pass filter and to a second band pass filter.

13. A variable bandwidth transmission device as defined in claim 12, wherein the first band pass filter outputs a signal that is the sum of the frequency of the local oscillator signal and the frequency of the bandwidth control signal.

14. A variable bandwidth transmission device as defined in claim 12, wherein said local oscillator manager includes a frequency divider receiving the signal output by said first band pass filter, said frequency divider outputting the signal at the first frequency.

15. A variable bandwidth transmission device as defined in claim 14, wherein said frequency divider divides the frequency of the signal output by said first band pass filter by two.

16. A variable bandwidth transmission device as defined in claim 13, wherein the second band pass filter outputs the signal at the second frequency that is the difference between the frequency of the local oscillator signal and the frequency of the bandwidth control signal.

17. A variable bandwidth transmission device as defined in claim 10, wherein said local oscillator manager includes a single side band up converter.

18. A variable bandwidth transmission device as defined in claim 17, wherein said oscillator manager includes a pair of said single side band up converters, each single side band up converter receiving as input the local oscillator signal and the bandwidth control signal, one of the single side band up converters releasing a signal at a frequency that is the sum of the frequency of the local oscillator signal and the bandwidth control signal and the other single side band up converter releasing a signal at a frequency that is the difference between the frequency of the local oscillator signal and the frequency of the bandwidth control signal.

19. a variable bandwidth transmission device as defined in claim 1, wherein the bandwidth control signal is related to a bandwidth of the message-bearing signal.

20. A variable bandwidth transmission device as defined in claim 19, wherein the bandwidth control signal is related to a bandwidth of the message bearing signal by a function f(X) where “X” is the bandwidth of the message bearing signal, said function being selected in the group consisting of
a) f(X)=A+X, where A is a constant;
b) f(x)=B*X, where B is a constant;
c) f(X)=C*(D+X), where C and D are constants.

21. A variable bandwidth transmission device comprising:
a) a first input, said input receiving a message bearing signal;
b) a second input for receiving a bandwidth control signal characterized by a frequency, the frequency being selectively variable;
c) means for processing the message bearing signal and the bandwidth control signal to generate an output signal characterized by a bandwidth, the means for processing the message-bearing signal being responsive to a change of frequency of the bandwidth control signal to alter the bandwidth of the output signal.

22. A local oscillator manager, comprising:
a) a first input for receiving a bandwidth control signal;
b) a second input for receiving a local oscillator signal;
c) a first single side band up converter for receiving the clock signal and the local oscillator signal for releasing a signal that is the sum of the frequency of the local oscillator signal and the frequency of the bandwidth control signal;
d) a second single side band up converter for receiving the bandwidth control signal and the local oscillator signal for releasing a signal that is the difference of the frequency of the local oscillator signal and the frequency of the bandwidth control signal.

23. A variable bandwidth reception device comprising:
a) a first input for receiving a message bearing signal;
b) a second input. for receiving a bandwidth control signal characterized by a frequency, the frequency being selectively variable;
c) a filtering stage for processing the message bearing signal and the bandwidth control signal to generate an output signal characterized by a bandwidth, said filtering stage being responsive to a change of frequency of the bandwidth control signal to alter the bandwidth of the output signal.

24. A variable bandwidth reception device as defined in claim 24, wherein said filtering stage is a spectral shaping filtering stage that includes a first spectral shaping filter and a second spectral shaping filter.

25. A variable bandwidth reception device as defined in claim 24, wherein said filtering stage includes band pass filters.

26. A variable bandwidth reception device as defined in claim 25, wherein said filtering stage includes a first mixer having two inputs and an output, the output of said first mixer being coupled to an input of a first band pass filter, one input of said first mixer being coupled to said first input for receiving the message bearing signal, the other input of said first mixer receiving a signal at a first frequency.

27. A variable bandwidth reception device as defined in claim 26, wherein said filtering stage includes a second mixer having two inputs and an output, one input of said second mixer being coupled to an output of said first band pass filter, one input of said second mixer receiving a signal at a second frequency, the output of said second mixer being coupled to an input of a second band pass filter.

28. A variable bandwidth reception device as defined in claim 27, wherein said filtering stage includes a third mixer having two inputs and an output, one input of said third mixer being coupled to an output of said second band pass filter, one input of said mixer receiving the signal at the first frequency, the output of said second mixer generating the output signal characterized by a bandwidth.

29. A variable bandwidth reception device as defined in claim 27, wherein said filtering stage includes an AD converter including a first input for receiving the output of said second band pass filter, a second input for receiving the signal at the first frequency and an output for releasing the output signal characterized by a bandwidth, the output signal characterized by a bandwidth being a digital signal.

30. A variable bandwidth reception device as defined in claim 29, wherein said AD converter is characterized by a sampling frequency, the first frequency defining the sampling frequency of said AD converter.

31. A variable bandwidth reception device as defined in claim 27, including a local oscillator manager including a local oscillator generating a local oscillator signal, said local oscillator manager being operative to generate from the local oscillator signal and from the bandwidth control signal the signal at the first frequency and the signal at the second frequency.

32. A variable bandwidth reception device as defined in claim 31, wherein said local oscillator manager includes a single side band up converter.

33. A variable bandwidth reception device as defined in claim 32, wherein said oscillator manager includes a pair of single side band up converters, each converter receiving as input the local oscillator signal and the bandwidth control signal, one of the single side band up converters releasing a signal at a frequency that is the sum of the frequency of the local oscillator signal and the frequency of the bandwidth control signal and the other single side band up converter releasing a signal at a frequency that is the difference between the frequency of the local oscillator signal and the frequency of the bandwidth control signal.

34. A variable bandwidth reception device as defined in claim 23, wherein the bandwidth control signal is related to a bandwidth of the message-bearing signal.

35. A variable bandwidth transmission device as defined in claim 34, wherein the bandwidth control signal is related to a bandwidth of the message bearing signal by a function f(X) where “X” is the bandwidth of the message bearing signal, said function being selected in the group consisting of
a) f(X)=A+X, where A is a constant;
b) f(X)=B*X, where B is a constant;
c) f(X)=C*(D+X), where C and D are constants.

36. A communication system comprising:
a) a transmitter as defined in claim 1 in RF communication with a receiver as defined in claim 23.
